(19) United States
(12) Patent Application Publication
(10) Pub. No.: US 2022/0277194 A1
(43) Pub. Date: Sep. 1, 2022

(54) STORAGE MEDIUM AND INFERENCE METHOD

(71) Applicant: FUJITSU LIMITED, Kawasaki-shi (JP)

(72) Inventors: Masayuki Hiromoto, Kawasaki (JP); Yi Ge, Bunkyo (JP)

(73) Assignee: FUJITSU LIMITED, Kawasaki-shi (JP)

(21) Appl. No.: 17/511,618

(22) Filed: Oct. 27, 2021

(30) Foreign Application Priority Data
Feb. 26, 2021 (JP) 2021-030394

(51) Int. Cl. G06N 3/08; G06N 5/04; G06K 9/62

(52) U.S. Cl. CPC G06N 3/08; G06N 5/04; G06K 9/6257; G06K 9/628

(57) ABSTRACT

A non-transitory computer-readable storage medium storing an inference program that causes at least one computer to execute a process, the process includes, training a neural network based on a plurality of pieces of first learning data that belongs to a first certain number of object classes and that does not include second learning data; generating a fully connected layer separated neural network by separating a fully connected layer of the neural network; generating a learning feature by using the fully connected layer separated neural network for each of a second certain number of pieces of the first learning data for each of the object classes; generating a class hyperdimensional vector for each of the object classes from each of the learning feature; and storing the class hyperdimensional vector in association with the object classes in a memory.

### CROSS-REFERENCE TO RELATED APPLICATION

This application is based upon and claims the benefit of priority of the prior Japanese Patent Application No. 2021-30394, filed on Feb. 26, 2021, the entire contents of which are incorporated herein by reference.

### FIELD

The embodiments discussed herein are related to a storage medium and an inference method.

### BACKGROUND

In recent years, research on a brain-inspired computing technology aimed at imitating a human brain has become active. For example, use of neural networks (NNs) is active in fields of image recognition and the like. For example, accuracy of image recognition is greatly improved by using deep learning (DL).

Conventionally, in order to perform recognition and classification by using deep learning, it is premised that learning using a large amount of training data is performed, and the learning takes a long time. On the other hand, humans may learn by looking at a small number of samples. As a technology for achieving such human recognition, few-shot learning has been proposed. The few-shot learning is a task of learning a new classification class by using as few samples as one or five. The few-shot learning is one of inductive transfer learning that uses a model learned in one task for another task.

The few-shot learning that learns classification classes by looking at K images of N classes is called N-way K-shot few-shot learning. For example, an example of 5-way 1-shot few-shot learning will be described. First, in a case where a dog and other four types of animals are objects of the few-shot learning, a large number of images that do not include these five types of animals are learned in advance. Then, only one image of each of the dog and the other four types of animals is shown. Thereafter, a photograph of a dog is caused to be specified from other photographs of a dog and the other four types of animals. Here, 5-way means that there are five types to be objects of the few-shot learning. Furthermore, 1-shot means learning a classification of each animal by looking at only one image.

As data sets used for such few-shot learning, there are Omniglot, which is handwritten characters in various languages, and mini-ImageNet, which is a lightweight version of ImageNet as an image database used in deep learning.

Furthermore, main methods of the few-shot learning are as follows. One method is a method called metric learning. The metric learning is a method of learning, in advance, a function that estimates a metric, which is similarity between two inputs. In the metric learning, it is possible to perform classification without learning an input of a new few shots when a distance may be measured accurately.

Another method is a method called meta-learning. The meta-learning is a method of learning a learning method, and in a case where the meta-learning is used as the few-shot learning, a task of performing inference from a small number of samples is learned. For example, in a case where the few-shot learning is performed by the meta-learning, a learning method suitable for the few-shot learning is learned by performing the learning by reproducing a situation at the time of a test in learning.

Moreover, as another method, an approach of learning a few shots after data augmentation may be considered. However, since this method converts the few shots into a large-shot problem, it may be said that it is not strictly the few-shot learning.

In this way, various methods have been proposed for the few-shot learning, but all of the methods still have a heavy learning load. On the other hand, there is a method of ensuring certain recognition accuracy while reducing a learning load by using a simple nearest-neighbor algorithm.

Furthermore, there is an elemental technology called hyper dimensional computing (HDC). In the HDC, processing of convoluting information into a simple ultra-long vector of about 1,000 dimensions by a simple arithmetic operation. The HDC is said to have high similarity to a brain because, for example, information is stored probabilistically and is robust against errors, and it is possible to store various types of information as the same simple ultra-long vectors.

Furthermore, as a conventional technology for deep learning, there is a technology for training a machine learning classifier to posts of social websites, and converting semantic vectors of posts that represent a plurality of features obtained from the machine learning classifier into high-dimensional vectors and classifying the resultant vectors by using K-means clustering. Furthermore, there is a technology for performing clustering by using a subspace of a high-dimensional vector space to which a content vector belongs, and selecting a subspace including a content vector close to an input vector input as a query from subspaces used for classification. Furthermore, there is a technology for adjusting, for a multi-layer neural network having a probing neuron in a hidden layer, the number of layers by removing an upper layer on the basis of a cost of the probing neuron after learning and setting, as an output layer, a probing neuron in an uppermost layer of remaining layers. Furthermore, there is a technology for inputting multidimensional vector data into a neural network having k clusters of output layers and outputting a classification probability for each of the k clusters. Furthermore, there is a technology for performing learning by using a set of chunks in which each of chunks includes a respective group of neural network layers other than a last layer, for accelerating neural network data parallel training in a plurality of graphics processing units (GPUs).

U.S Patent Application Publication No. 2018/0189603, Japanese Laid-open Patent Publication No. 2010-15441, Japanese Laid-open Patent Publication No. 2015-95215, Japanese Laid-open Patent Publication No. 2019-139651, and U.S Patent Application Publication No. 2019/0188560 are disclosed as related art.

### SUMMARY

According to an aspect of the embodiments, a non-transitory computer-readable storage medium storing an inference program that causes at least one computer to execute a process, the process includes, training a neural network based on a plurality of pieces of first learning data that belongs to a first certain number of object classes and that does not include second learning data; generating a fully connected layer separated neural network by separating a fully connected layer of the neural network; generating a learning feature by using the fully connected layer separated neural network for each of a second certain number of pieces of the first learning data for each of the object classes; generating a class hyperdimensional vector for each of the object classes from each of the learning feature; and storing the class hyperdimensional vector in association with the object classes in a memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an inference apparatus according to a first embodiment;

FIG. 2 is a diagram for describing a hyperdimensional vector (HV);

FIG. 3 is a diagram illustrating a representation example of a set by addition;

FIG. 4 is a diagram for describing learning and inference in hyper dimensional computing (HDC);

FIG. 5 is a conceptual diagram of few-shot learning by the inference apparatus according to the first embodiment;

FIG. 6 is a flowchart of the few-shot learning by the inference apparatus according to the first embodiment;

FIG. 7 is a block diagram of an inference apparatus according to a second embodiment;

FIG. 8 is a comparison diagram of class HVs with and without low-quality learning data;

FIG. 9 is a diagram for describing thinning out of the low-quality learning data;

FIG. 10 is a diagram illustrating a class HV in a case where the low-quality learning data is thinned out;

FIG. 11 is a flowchart of few-shot learning by the inference apparatus according to the second embodiment;

FIG. 12 is a diagram for describing other thinning methods; and

FIG. 13 is a diagram illustrating a hardware configuration of a computer that executes an inference program according to the embodiments.

### DESCRIPTION OF EMBODIMENTS

In the various methods conventionally proposed for the few-shot learning, a learning load is heavy. Thus, it is difficult to shorten a learning time while ensuring classification accuracy. Furthermore, the technology for classifying a plurality of features obtained from a machine learning classifier by the K-means clustering may improve efficiency of machine learning, but a method for applying the technology to the few-shot learning is not indicated, and thus it is difficult to apply the technology. Furthermore, in any of the technology for selecting a subspace close to an input from a vector space, the technology for removing an upper layer on the basis of a probing neuron after learning, the technology for outputting a classification probability for each cluster, and the technology for performing learning by using a set of chunks, the few-shot learning is not considered. Therefore, it is difficult to improve the efficiency while ensuring the classification accuracy of the few-shot learning regardless of which technology is used.

The disclosed technology has been made in view of the above, and an object of the disclosed technology is to provide an inference program and an inference method that improve efficiency of learning and classification while ensuring classification accuracy of few-shot learning.

In one aspect, an embodiment may improve efficiency of learning and classification while ensuring classification accuracy of few-shot learning.

Hereinafter, embodiments of an inference program and an inference method disclosed in the present application will be described in detail with reference to the drawings. Note that the following embodiments do not limit the inference program and the inference method disclosed in the present application.

### First Embodiment

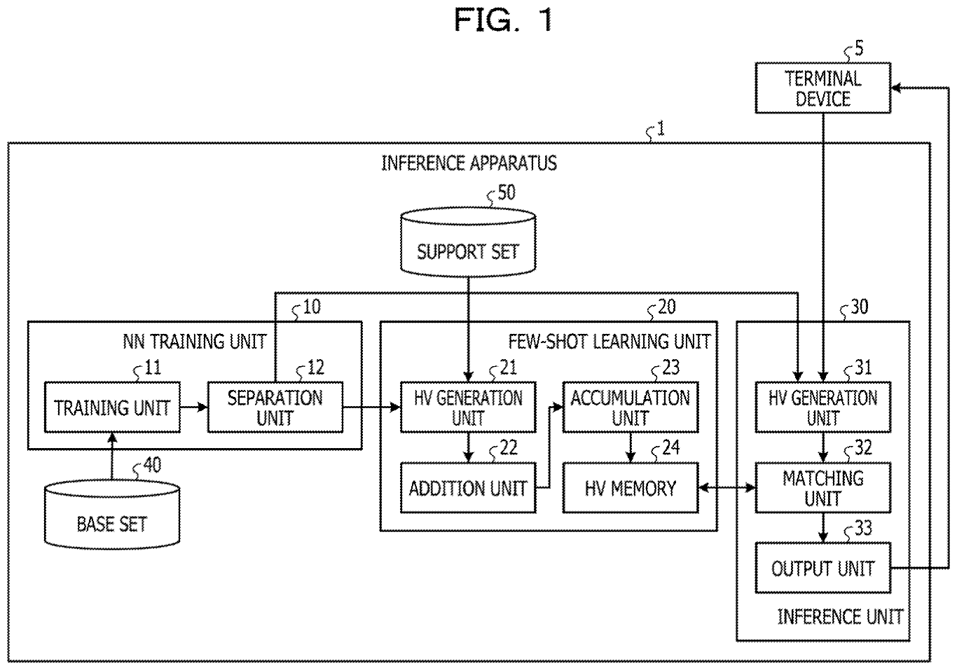

FIG. 1 is a block diagram of an inference apparatus according to a first embodiment. The inference apparatus 1 is an apparatus that performs few-shot learning and inference from given image data. As illustrated in FIG. 1, the inference apparatus 1 includes a neural network (NN) training unit 10, a few-shot learning unit 20, an inference unit 30, a base set 40, and a support set 50. In the following, an object to be inferred by using query data after the few-shot learning will be described as an inference object. Here, the few-shot learning using image data will be described.

The base set 40 is a collection of learning data used to train a neural network. The base set 40 is a set of a large amount of learning data that does not include data of a class of the inference object. For example, in a case where the inference object is a dog, the base set 40 includes learning data of a plurality of classes for objects other than a dog. The base set 40 is, for example, learning data of 64 classes and 600 samples for each class.

The support set 50 is a collection of learning data used for the few-shot learning, and is a collection of learning data including data of a class of the inference object. The learning data included in the support set 50 is data of classes not included in the base set 40. For example, in a case where the inference object is a dog, the support set 50 includes image data of a plurality of classes including a dog. The support set 50 includes, for example, image data of 20 classes and image data of 600 samples for each class.

Here, in a case where N-way K-shot few-shot learning is performed, the support set 50 needs only K pieces of learning data for each class of at least N classes, for example, needs only N×K pieces of learning data. Furthermore, in the present embodiment, since data used for learning from the support set 50 is smaller than data used for learning from the base set 40, the learning data of the support set 50 is smaller than that of the base set 40. However, a relationship between sizes of the learning data is not limited to this.

The NN training unit 10 trains a neural network and generates a trained neural network. The NN training unit 10 includes a training unit 11 and a separation unit 12.

The training unit 11 uses learning data stored in the base set 40 to train a neural network in the same manner as class classification using normal deep learning. Then, the training unit 11 outputs the trained neural network to the separation unit 12. For implementation of the training unit 11, for example, a graphics processing unit (GPU) or a dedicated processor for deep learning is used.

The separation unit 12 receives an input of a trained neural network from the NN training unit 10. Next, the separation unit 12 separates a fully connected layer (FC layer), which is a last layer in the acquired neural network. Then, the separation unit 12 outputs the trained neural network from which the fully connected layer is separated to a hyperdimensional vector (HV) generation unit 21 of the few-shot learning unit 20. In the following, the trained neural network from which the fully connected layer is separated is referred to as “fully connected layer separated neural network”.

The few-shot learning unit 20 performs the few-shot learning using hyper dimensional computing (HDC) and performs class classification for inference. Here, the HDC will be described.

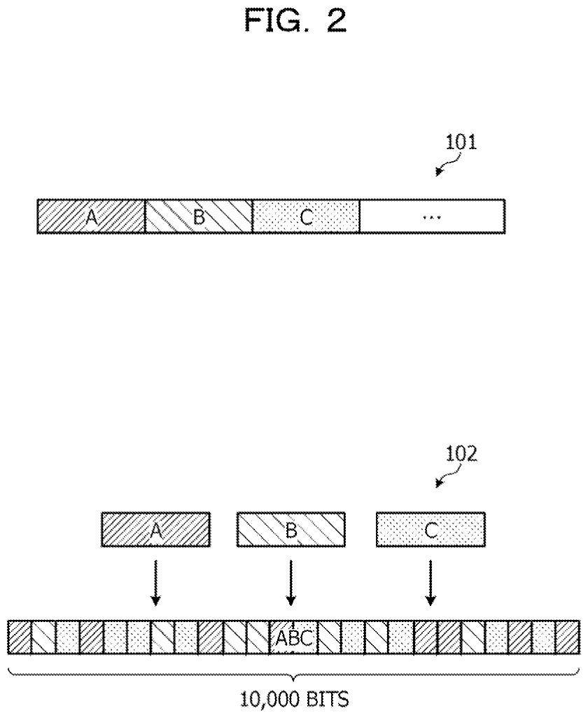

The HDC uses an HV for data representation. FIG. 2 is a diagram for describing the HV. The HV represents data in a distributed manner by hyperdimensional vectors of 10,000 dimensions or more. The HV represents various types of data by vectors of the same bit length.

In normal data representation, each piece of data such as A, B, and C is collectively represented as indicated in data 101. On the other hand, as indicated in data 102, by hyperdimensional vectors, the data such as A, B, and C are represented in a distributed manner. In the HDC, data may be manipulated by a simple operation such as addition or multiplication. Furthermore, in the HDC, it is possible to represent a relationship between pieces of data by addition or multiplication.

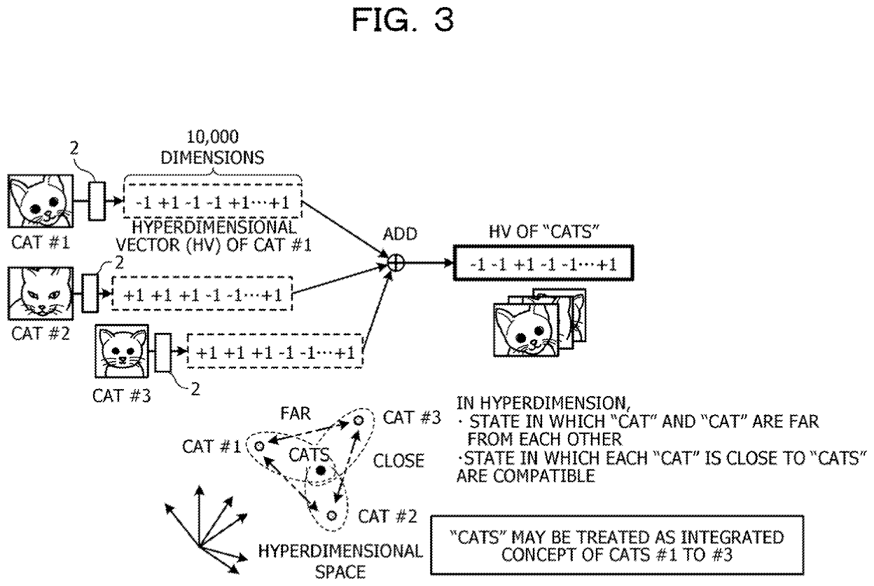

FIG. 3 is a diagram illustrating a representation example of a set by addition. In FIG. 3, an HV of a cat #1, an HV of a cat #2, and an HV of a cat #3 are generated by an HV encoder 2 from an image of the cat #1, an image of the cat #2, and an image of the cat #3, respectively. Each element of an HV is “+1” or “−1”. The cats #1 to #3 are each represented by an HV of 10,000 dimensions.

As illustrated in FIG. 3, an HV obtained by adding the HV of the cat #1 to the HV of the cat #3 represents a set including the cat #1, the cat #2, and the cat #3, for example, “cats”. Here, the addition of the HVs is addition for each element. In a case where an addition result is positive, the addition result is replaced with “+1”, and in a case where an addition result is negative, the addition result is replaced with “−1”. In a case where an addition result is “0”, the addition result is replaced with “+1” or “−1” under a predetermined rule. This addition is sometimes referred to as “average”. In the HDC, a state in which a “cat” and a “cat” are far from each other and a state in which each “cat” is close to “cats” are compatible. In the HDC, the “cats” may be treated as an integrated concept of the cats #1 to #3.

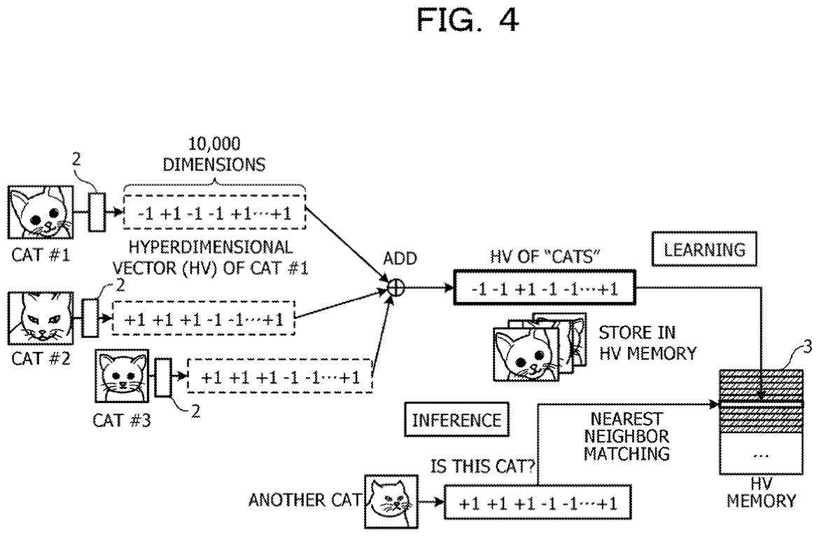

FIG. 4 is a diagram for describing learning and inference in the HDC. As illustrated in FIG. 4, in a learning phase, the HV of the cat #1, the HV of the cat #2, and the HV of the cat #3 are generated by the HV encoder 2 from the image of the cat #1, the image of the cat #2, and the image of the cat #3, respectively. Then, the HV of the cat #1, the HV of the cat #2, and the HV of the cat #3 are added to generate the HV of “cats”, and the generated HV is associated with the “cats” and stored in an HV memory 3.

Then, in an inference phase, an HV is generated from an image of another cat, the HV of the “cats” is retrieved from the HV memory 3 as an HV having the highest degree of matching as a result of nearest neighbor matching with the generated HV, and “cat” is output as an inference result. Here, the nearest neighbor matching is to calculate a degree of matching between HVs by a dot product between the HVs and output a class having the highest degree of matching. Assuming that two HVs are Hᵢ and Hⱼ, a dot product p=Hᵢ·Hⱼ is D (a dimension of HV) when Hᵢ and Hⱼ match, and −D when Hᵢ and Hⱼ are orthogonal. Since the HV memory 3 is an associative memory, the nearest neighbor matching is performed at high speed. The HV memory 3 here corresponds to an HV memory 24 of the inference apparatus 1 described later.

Note that, in the inference apparatus 1 according to the embodiment, an HV is generated on the basis of a feature amount extracted by the fully connected layer separated neural network, not by the HV encoder 2. In the inference apparatus 1 according to the embodiment, pattern processing of feature amount extraction from an image is performed by the fully connected layer separated neural network, and symbolic processing of HV accumulation in the HV memory 3 and association using the HV memory 3 is performed by the HDC. In this way, by using advantages of the NN and the HDC, the inference apparatus 1 according to the embodiment may efficiently perform training and inference.

On the basis of the above, returning to FIG. 1, the details of the few-shot learning unit 20 will be described. As illustrated in FIG. 1, the few-shot learning unit 20 includes an HV generation unit 21, an addition unit 22, an accumulation unit 23, and the HV memory 24.

The HV generation unit 21 receives an input of the fully connected layer separated neural network from the separation unit 12. Then, the HV generation unit 21 stores the fully connected layer separated neural network.

Next, the HV generation unit 21 acquires, as learning samples, learning data for the few-shot learning including a dog to be a recognition object from the support set 50. Here, in a case where N-way K-shot few-shot learning is performed, the HV generation unit 21 acquires K pieces of learning data for each class for N types of classes including a dog.

Then, the HV generation unit 21 inputs each piece of image information, which is the acquired learning data, to the fully connected layer separated neural network. Then, the HV generation unit 21 acquires, for each learning sample, an image feature vector output from the fully connected layer separated neural network. The image feature vector is, for example, a vector of an output value of a node of an output layer of the fully connected layer separated neural network.

Next, the HV generation unit 21 executes, for each class, HV encoding for converting the image feature vector obtained from each learning sample into an HV. For example, in the case of a dog class, the HV generation unit 21 converts each of image feature vectors obtained from images of dogs, which are learning samples, into an HV.

For example, assuming that the image feature vector is x and a dimension of x is n, the HV generation unit 21 centers x. For example, the HV generation unit 21 calculates an average value vector of x by using Expression (1) below, and subtracts the average value vector of x from x as indicated in Expression (2). In Expression (1), D_{base} is a set of x, and |D_{base}| is a size of the set of x.

$$[ Expression 1 ]$$

$$\overline{x} = \frac{1}{\vert {D}_{base} \vert} {\sum }_{x ∈ Dbase} x \qquad ( 1 )$$

$$[ Expression 2 ]$$

$$x ← x - \overline{x} \qquad ( 2 )$$

Then, the HV generation unit 21 normalizes x. For example, the HV generation unit 21 divides x by an L2 norm of x, as indicated in Expression (3) below. Note that the HV generation unit 21 does not have to perform centering and normalization.

$$[ Expression 3 ]$$

$$x ← \frac{x}{{‖ x ‖}_{2}} \qquad ( 3 )$$

Next, the HV generation unit 21 quantizes each element of x into Q steps to generate q={q₁, q₂, . . . , qₙ}. Here, the HV generation unit 21 may perform linear quantization or logarithmic quantization.

Furthermore, the HV generation unit 21 generates a base HV(Lᵢ) indicated in Expression (4) below. In Expression (4), D is a dimension of the HV, for example, 10,000. The HV generation unit 21 randomly generates L₁ and flips D/Q bits at random positions to generate L₂ to L_{Q} in order. Adjacent Lᵢs are close to each other, and L₁ and L_{Q} are orthogonal to each other.

[Expression 4]

L={L₁, L₂, . . . , L_{Q}}, Lᵢ∈{−1, +1}^{D} (4)

Then, the HV generation unit 21 generates a channel HV(Cᵢ) indicated in Expression (5) below. The HV generation unit 21 randomly generates Cᵢs so that all the Cᵢs are substantially orthogonal to each other.

[Expression 5]

C={C₁, C₂, . . . , Cₙ}, Cᵢ∈{−1, +1}^{D} (5)

Then, the HV generation unit 21 calculates an image HV by using Expression (6) below. In Expression (6), “.” is a dot product. Sometimes “·” is called an inner product.

[Expression 6]

X=sign(L_{q}_{₁}·C₁+L_{q}_{₂}·C₂+ . . . +L_{q}_{ₙ}·Cₙ)∈{−1, +1}^{D} (6)

Thereafter, the HV generation unit 21 outputs the HVs corresponding to the learning samples for each class to the addition unit 22.

The addition unit 22 receives an input of HVs corresponding to learning samples for each class from the HV generation unit 21. Then, the addition unit 22 adds the HVs for each class by using Expression (7) below to obtain a class HV.

$$[ Expression 7 ]$$

$$\overline{X} = sign \sum X \qquad ( 7 )$$

Thereafter, the addition unit 22 outputs the class HV for each class to the accumulation unit 23.

The accumulation unit 23 receives an input of a class HV for each class from the addition unit 22. Then, the accumulation unit 23 accumulates the class HV generated by the addition unit 22 in the HV memory 24 in association with the class. The HV memory 24 is an associative memory.

The inference unit 30 receives query data, which is image data of the inference object, from an external terminal device 5. The query data is one piece of image data different from the learning data used when the few-shot learning is executed. Then, the inference unit 30 specifies and outputs which class the query data belongs to among classes for which the few-shot learning has been performed. Hereinafter, the details of the inference unit 30 will be described. As illustrated in FIG. 1, the inference unit 30 includes an HV generation unit 31, a matching unit 32, and an output unit 33.

The HV generation unit 31 receives an input of the fully connected layer separated neural network from the separation unit 12. Then, the HV generation unit 31 stores the fully connected layer separated neural network.

Next, the HV generation unit 31 acquires query data transmitted from the terminal device 5. For example, in a case where a dog is the inference object, the HV generation unit 31 acquires image data of a dog. Here, in the present embodiment, the HV generation unit 31 acquires the query data from the external terminal device 5, but the embodiment is not limited to this. For example, among pieces of image data included in the support set 50, image data different from the learning data used at the time of the few-shot learning may be used as the query data.

The HV generation unit 31 inputs the query data to the fully connected layer separated neural network. Then, the HV generation unit 31 acquires an image feature vector of the query data output from the fully connected layer separated neural network.

Next, the HV generation unit 31 converts the image feature vector obtained from the query data into an HV. Then, the HV generation unit 31 outputs the HV generated from the query data to the matching unit 32. In the following, the HV created from the query data will be referred to as a query HV.

The matching unit 32 receives an input of a query HV from the HV generation unit 31. The matching unit 32 compares each class HV stored in the HV memory 24 with the query HV, retrieves a class HV closest to the query HV, and determines a class of the class HV that is a retrieval result as an output class. Thereafter, the matching unit 32 outputs information regarding the determined output class to the output unit 33.

For example, the matching unit 32 determines the output class by performing the following nearest neighbor matching for each class HV by using the query HV. For example, the matching unit 32 calculates a degree of matching between each class HV and the query HV by a dot product p represented by pᵢⱼ=Hᵢ·Hⱼ. In this case, p is a scalar value, and for example, p=D in a case where each class HV and the query HV match, and p=−D in a case where each class HV and the query HV are orthogonal to each other. As described above, D is a dimension of the HV, for example, 10,000. Then, the matching unit 32 determines a class of a class HV having the highest degree of matching as the output class.

The output unit 33 acquires information regarding an output class from the matching unit 32. Then, the output unit 33 transmits the output class to the terminal device 5 as an inference result of a class to which query data belongs.

Here, in the present embodiment, in order to clarify each of the functions of the few-shot learning unit 20 and the inference unit 30, the HV generation unit 21 and the HV generation unit 31 are arranged in the few-shot learning unit 20 and the inference unit 30, respectively. However, since the same processing is performed, the HV generation unit 21 and the HV generation unit 31 may be integrated into one. For example, the HV generation unit 21 may generate a query HV from query data acquired from the terminal device 5, and the inference unit 30 may acquire the query HV from the HV generation unit 21 and perform inference.

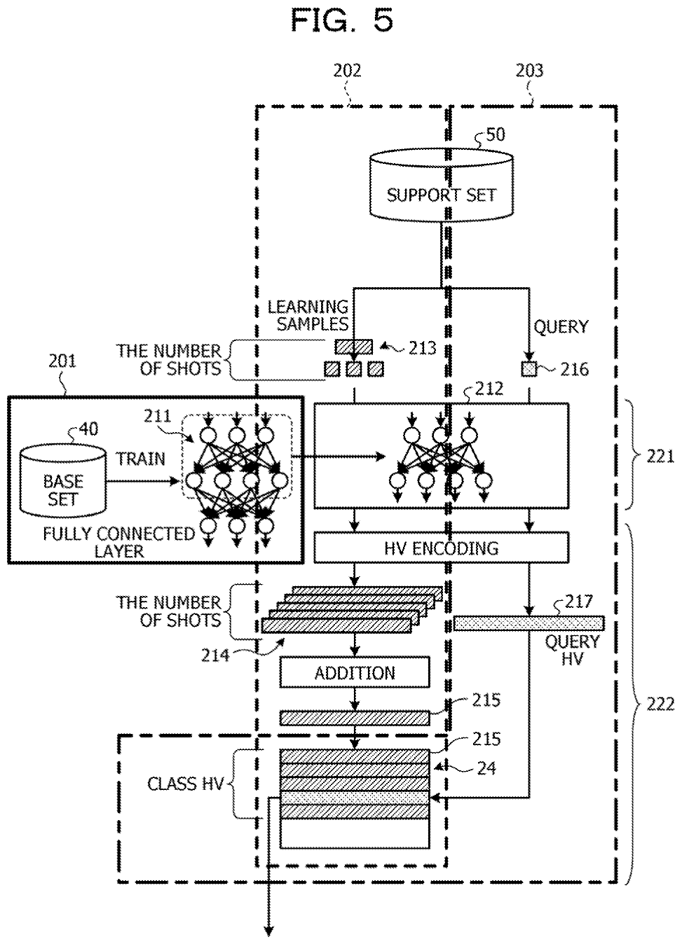

FIG. 5 is a conceptual diagram of the few-shot learning by the inference apparatus according to the first embodiment. Next, with reference to FIG. 5, an overall image of the few-shot learning by the inference apparatus 1 according to the present embodiment will be described.

In FIG. 5, processing 201 represents processing of training a neural network executed by the NN training unit 10. The training unit 11 inputs learning data acquired from the base set 40 to a neural network 211 and executes training of the neural network 211 Next, the separation unit 12 separates a fully connected layer from the trained neural network to generate a fully connected layer separated neural network 212.

Processing 202 represents processing of the few-shot learning executed by the few-shot learning unit 20. The HV generation unit 21 acquires the fully connected layer separated neural network 212. Next, the HV generation unit 21 acquires, as learning samples, pieces of learning data 213 corresponding to the number of shots from the support set 50 for each of classes corresponding to the number of ways to be objects of the few-shot learning. In FIG. 5, the learning data 213 for one class is described.

Next, the HV generation unit 21 inputs the learning data 213 to the fully connected layer separated neural network 212 and acquires an image feature vector of each piece of the learning data 213. Next, the HV generation unit 21 performs HV encoding on the image feature vector of each piece of the learning data 213, and generates HVs 214 corresponding to the number of shots for each class to be the object of the few-shot learning. Next, the addition unit 22 adds the HVs corresponding to the number of shots for each class to generate a class HV 215 for each class. The accumulation unit 23 stores and accumulates the class HV 215 for each class in the HV memory 24.

Processing 203 represents inference processing executed by the inference unit 30. Here, a case where data included in the support set 50 is used as query data will be described. The HV generation unit 31 acquires query data 216 to be an inference object from the support set 50. The HV generation unit 31 inputs the query data 216 to the fully connected layer separated neural network 212 and acquires an image feature vector of the query data 216. Next, the HV generation unit 31 performs HV encoding on the image feature vector of the query data 216 and generates a query HV 217. The matching unit 32 compares each class HV 215 stored in the HV memory 24 with the query HV 217, retrieves a class HV 215 closest to the query HV 217, and determines a class of the class HV 215 that is a retrieval result as an output class. The output unit 33 outputs the output class determined by the matching unit 32 as a class of the query data 216.

In FIG. 5, the processing executed in a range 221 is pattern processing of feature amount extraction from an image performed by using a neural network. Furthermore, the processing executed in a range 222 is symbolic processing of HV accumulation in the HV memory 24 and association using the HV memory 24.

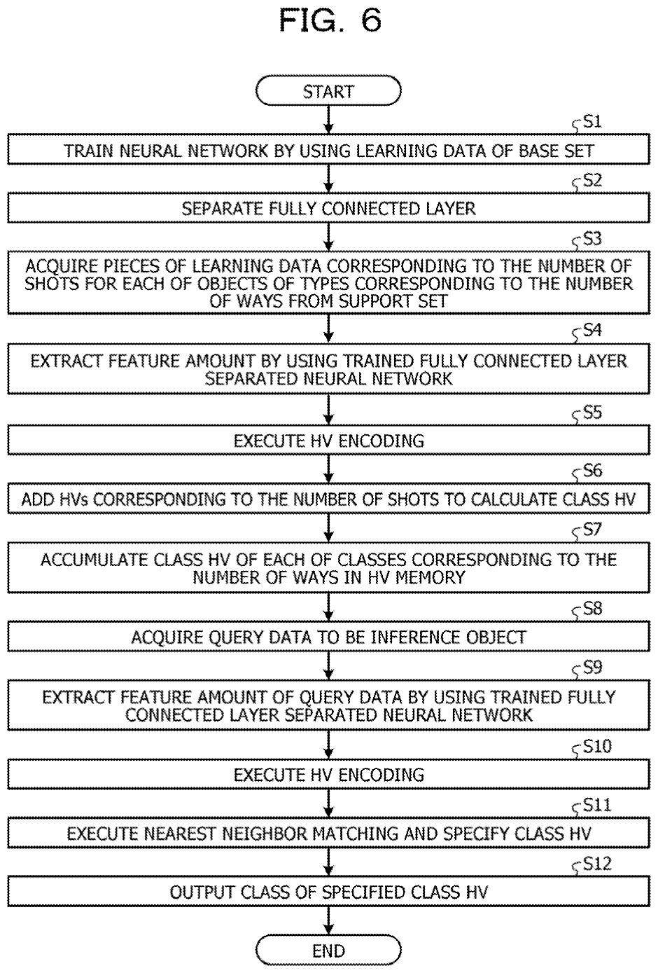

FIG. 6 is a flowchart of the few-shot learning by the inference apparatus according to the first embodiment. Next, with reference to FIG. 6, a flow of the few-shot learning by the inference apparatus 1 according to the first embodiment will be described.

The training unit 11 executes training of a neural network by using learning data acquired from the base set 40 (Step S1).

The separation unit 12 separates a fully connected layer from the trained neural network to generate a fully connected layer separated neural network (Step S2).

The HV generation unit 21 acquires pieces of learning data corresponding to the number of shots for each of objects of types corresponding to the number of ways from the support set 50 (Step S3).

The HV generation unit 21 inputs the learning data to the trained fully connected layer separated neural network, extracts a feature amount of each piece of the learning data, and acquires an image feature vector (Step S4).

Next, the HV generation unit 21 executes HV encoding on each of the acquired image feature vectors and generates HVs corresponding to the number of shots for each of classes corresponding to the number of ways (Step S5).

The addition unit 22 adds the HVs corresponding to the number of shots for each of the classes corresponding to the number of ways to calculate a class HV (Step S6).

The accumulation unit 23 accumulates the class HV of each of the classes corresponding to the number of ways in the HV memory 24 (Step S7).

The HV generation unit 31 acquires query data to be an inference object (Step S8).

The HV generation unit 31 inputs the query data to the trained fully connected layer separated neural network, extracts a feature amount of the query data, and acquires an image feature vector (Step S9).

The HV generation unit 31 executes HV encoding on the image feature vector of the query data and acquires a query HV (Step S10).

The matching unit 32 executes nearest neighbor matching by using the query HV for the class HVs accumulated in the HV memory 24, and specifies a class HV closest to the query HV (Step S11).

The output unit 33 outputs a class of the class HV specified by the matching unit 32 as a class to which the query data belongs (Step S12).

As described above, the inference apparatus according to the present embodiment separates a fully connected layer of a trained neural network to generate a fully connected layer separated neural network. Next, the inference apparatus extracts feature amounts by using the fully connected layer separated neural network for pieces of learning data corresponding to the number of shots for each of objects corresponding to the number of ways, and obtains and accumulates a class HV by using HDC for the extracted feature amounts. Thereafter, the inference apparatus obtains a query HV for query data as an inference object by using the fully connected layer separated neural network and the HDC, and determines a class of a class HV closest to the query HV as a class of the query data, thereby performing inference using few-shot learning. As described above, by not performing processing in the fully connected layer of the neural network, a processing load at the time of learning and a processing load at the time of inference in the few-shot learning may be reduced. Furthermore, by performing inference processing by using the HDC, it is possible to suppress deterioration of classification accuracy. Therefore, it is possible to improve efficiency of learning and classification while ensuring the classification accuracy of the few-shot learning.

### Second Embodiment

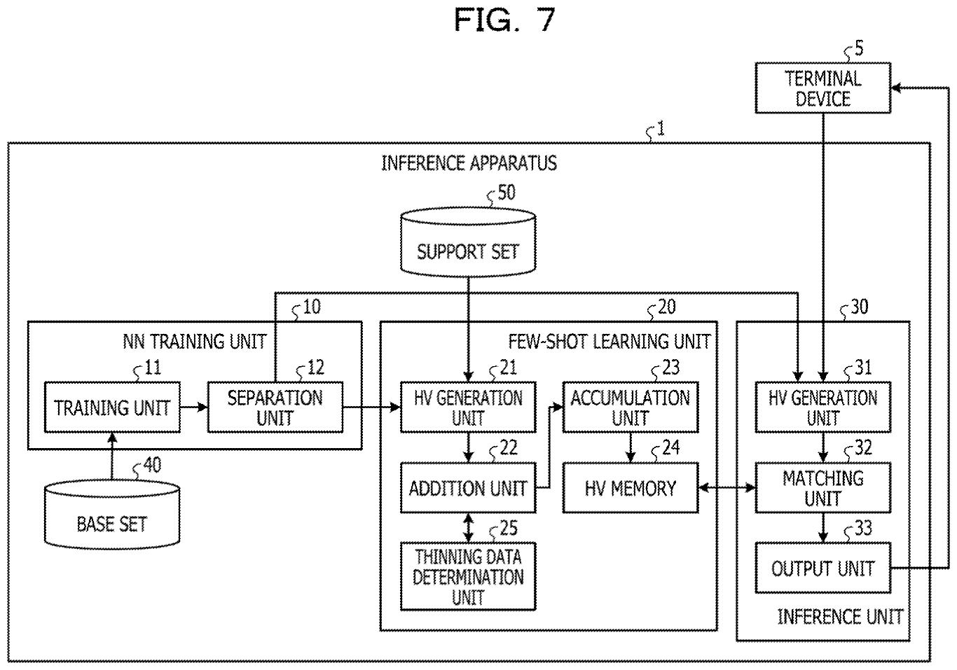

FIG. 7 is a block diagram of an inference apparatus according to a second embodiment. An inference apparatus 1 according to the second embodiment is different from the inference apparatus 1 of the first embodiment in that low-quality learning data in few-shot learning is thinned out when a class HV is created. In the following, thinning processing of learning data in the few-shot learning will be mainly described. In the following description, descriptions of operations of respective units similar to those of the first embodiment will be omitted.

In the few-shot learning, a data set such as mini-ImageNet is used as learning data, but such a data set may include low-quality data in learning that is difficult to discriminate. For example, the low-quality data is an image of a dog in which a dog is captured in a screen but a main subject may be recognized as another object. In a case where the few-shot learning is performed with such low-quality learning data included in learning samples corresponding to the number of shots, it may be difficult to obtain an appropriate classification result at the time of inference due to an influence of the low-quality learning data.

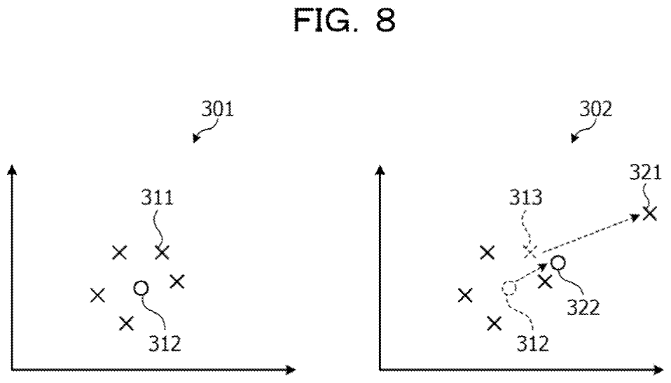

FIG. 8 is a comparison diagram of class HVs with and without low-quality learning data. Graphs 301 and 302 of FIG. 8 represent coordinate spaces of HVs. In FIG. 8, dimensions of the HVs are represented in two dimensions. For example, in the graphs 301 and 302, a vertical axis represents a dimension in one direction in a case where the dimensions of the HVs are represented in two dimensions, and a horizontal axis represents a dimension in another direction.

The graph 301 is a graph in a case where low-quality learning data is not included. Each point 311 is an HV representing each piece of image data. In addition, a point 312 is a class HV, which is a result of adding the points 311. In this case, the point 312 exists at a short distance from each of the points 311, and it may be said that the class HV collectively represents the HVs.

On the other hand, the graph 302 is a graph in a case where low-quality learning data is included. In the graph 302, a point 313 among the points 311 representing the HVs in the graph 301 is moved to a position of a point 321. An HV represented by the point 321 is separated from the points representing other HVs, and is the low-quality learning data. In this case, when a class HV is obtained by including the HV represented by the point 321, the class HV at the point 312 in the graph 301 is moved to a position of a point 322 by being influenced by the point 321 representing the low-quality learning data. In this case, there is a point far from the point 322 among the points representing the HVs, and it may not be said that the class HV collectively represents the HVs. Thus, in a case where inference is performed by using such a class HV, it becomes difficult to obtain an appropriate classification result.

Therefore, the inference apparatus 1 according to the present embodiment improves classification accuracy by creating a class HV by thinning out learning data determined to be low-quality learning data in learning, as described below. As illustrated in FIG. 7, the few-shot learning unit 20 according to the present embodiment includes a thinning data determination unit 25 in addition to the HV generation unit 21, the addition unit 22, the accumulation unit 23, and the HV memory 24.

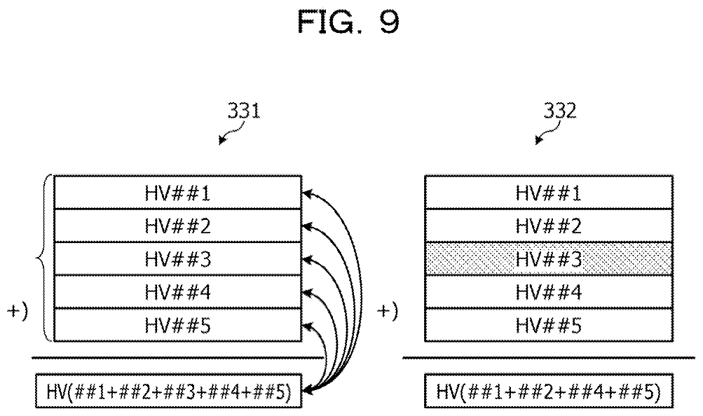

The addition unit 22 performs following processing for each of classes corresponding to the number of ways. The addition unit 22 receives an input of HVs corresponding to the number of shots from the HV generation unit 21. Then, the addition unit 22 adds the HVs corresponding to the number of shots to generate a temporary class HV. FIG. 9 is a diagram for describing thinning out of low-quality learning data. FIG. 9 is a diagram representing a case where HVs ##1 to ##5 exist as HVs corresponding to the number of shots. For example, the addition unit 22 performs calculation 331 to add the HV ##1 to the HV ##5 to obtain an HV (##1+##2+##3+##4+##5) as a temporary class HV. Then, the addition unit 22 outputs the generated temporary class HV and the HVs corresponding to the number of shots to the thinning data determination unit 25.

Thereafter, the addition unit 22 receives an input of a determination result of an HV to be thinned out from the thinning data determination unit 25. In a case where the determination result indicates that there is no object to be thinned out, the addition unit 22 determines the temporary class HV as a class HV and outputs the class HV to the accumulation unit 23.

On the other hand, in a case where an HV to be thinned out is notified as the determination result, the addition unit 22 adds HVs other than the HV specified to be thinned out among the HVs corresponding to the number of shots to obtain a class HV. For example, as illustrated in FIG. 9, in a case where the HV ##3 is thinned out, the addition unit 22 performs calculation 332 to add the HV ##1, the HV ##2, the HV ##4, and the HV ##5 to obtain an HV (##1+##2+##4+##5) as a class HV. Then, the addition unit 22 outputs the obtained class HV to the accumulation unit 23. Here, the method of thinning out an HV may be another method, and for example, the addition unit 22 may replace all elements of the specified HV with an array of 0 and add the HVs corresponding to the number of shots to obtain a class HV.

The thinning data determination unit 25 receives, for each of classes corresponding to the number of ways, an input of a temporary class HV and HVs corresponding to the number of shots from the addition unit 22. Next, the thinning data determination unit 25 obtains a distance between the temporary class HV and each of the HVs corresponding to the number of shots. For example, the thinning data determination unit 25 obtains the distance between the temporary class HV and each of the HVs by using a dot product.

Next, the thinning data determination unit 25 compares each of the obtained distances with a predetermined distance threshold. In a case where there is an HV whose distance from the temporary class HV is greater than the distance threshold, the thinning data determination unit 25 determines the HV as an object to be thinned out. Then, the thinning data determination unit 25 notifies the addition unit 22 of the HV to be thinned out. On the other hand, in a case where there is no HV whose distance from the temporary class HV is greater than the distance threshold, the thinning data determination unit 25 notifies the addition unit 22 that there is no object to be thinned out.

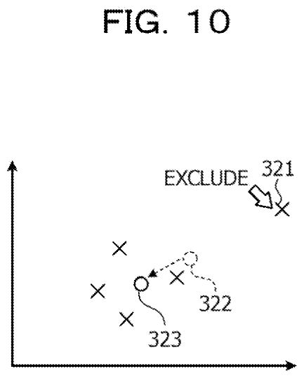

FIG. 10 is a diagram illustrating a class HV in a case where low-quality learning data is thinned out. FIG. 10 represents a coordinate space of HVs. In FIG. 10, a vertical axis represents a dimension in one direction in a case where the dimensions of the HVs are represented in two dimensions, and a horizontal axis represents a dimension in another direction. FIG. 10 represents a case where low-quality learning data is thinned out for each HV represented by the graph 302 of FIG. 8.

In this case, the addition unit 22 calculates a temporary class HV represented by the point 322. Then, the thinning data determination unit 25 obtains a distance between the point 322, which is the temporary class HV, and each of the points representing other HVs. Then, since a distance between the point 321 and the point 322 is greater than a distance threshold, the thinning data determination unit 25 determines the HV represented by the point 321 as an HV of low-quality learning data, and determines the HV represented by the point 321 as an object to be thinned out. The addition unit 22 receives a notification from the thinning data determination unit 25 that the HV represented by the point 321 is the object to be thinned out, and adds the HVs other than the HV represented by the point 321 to obtain a class HV represented by a point 323. In this case, a position of the class HV moves from the point 322, which is the temporary class HV, to the point 323, which is the class HV. The point 323 exists at a short distance from each of the points representing the HVs other than the point 321, and it may be said that this class HV may collectively represent the HVs.

Then, the accumulation unit 23 stores and accumulates, in the HV memory 24, a class HV of each class obtained by using learning data obtained by thinning out low-quality learning data in learning.

The matching unit 32 performs nearest neighbor matching by using a class HV obtained by thinning out low-quality learning data in learning, and determines a class to which query data belongs.

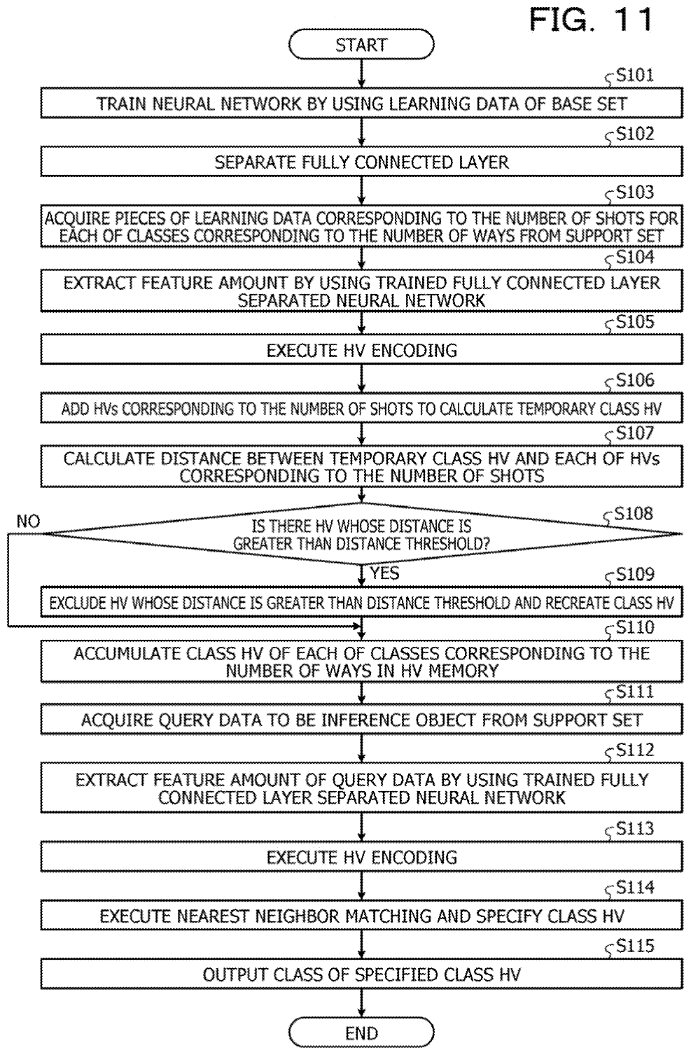

FIG. 11 is a flowchart of the few-shot learning by the inference apparatus according to the second embodiment. Next, with reference to FIG. 11, a flow of the few-shot learning by the inference apparatus 1 according to the second embodiment will be described.

The training unit 11 executes training of a neural network by using learning data acquired from the base set 40 (Step S101).

The separation unit 12 separates a fully connected layer from the trained neural network to generate a fully connected layer separated neural network (Step S102).

The HV generation unit 21 acquires pieces of learning data corresponding to the number of shots for each of objects of types corresponding to the number of ways from the support set 50 (Step S103).

The HV generation unit 21 inputs the learning data to the trained fully connected layer separated neural network, extracts a feature amount of each piece of the learning data, and acquires an image feature vector (Step S104).

Next, the HV generation unit 21 executes HV encoding on each of the acquired image feature vectors and generates HVs corresponding to the number of shots for each of classes corresponding to the number of ways (Step S105).

The addition unit 22 adds the HVs corresponding to the number of shots for each of the classes corresponding to the number of ways to calculate a temporary class HV (Step S106).

The thinning data determination unit 25 calculates a distance between the temporary class HV and each of the HVs corresponding to the number of shots for each of the classes corresponding to the number of ways (Step S107).

Next, the thinning data determination unit 25 determines whether or not there is an HV whose distance from the temporary class HV is greater than a distance threshold for each of the classes corresponding to the number of ways (Step S108).

In a case where there is no HV whose distance from the temporary class HV is greater than the distance threshold (Step S108: No), the thinning data determination unit 25 notifies the addition unit 22 that there is no object to be thinned out. The addition unit 22 outputs all the temporary class HVs as class HVs to the accumulation unit 23. Thereafter, the few-shot learning processing proceeds to Step S110.

On the other hand, in a case where there is an HV whose distance from the temporary class HV is greater than the distance threshold (Step S108: Yes), the thinning data determination unit 25 notifies the addition unit 22 of the HV whose distance from the temporary class HV is greater than the distance threshold as an HV to be thinned out. The addition unit 22 excludes the HV whose distance from the temporary class HV is greater than the distance threshold, and recreates a class HV of the class (Step S109). Furthermore, for another class, the addition unit 22 determines the temporary class HV as a class HV. Then, the addition unit 22 outputs the class HVs to the accumulation unit 23. Thereafter, the few-shot learning processing proceeds to Step S110.

The accumulation unit 23 accumulates the class HV of each of the classes corresponding to the number of ways in the HV memory 24 (Step S110).

The HV generation unit 31 acquires query data to be an inference object (Step S111).

The HV generation unit 31 inputs the query data to the trained fully connected layer separated neural network, extracts a feature amount of the query data, and acquires an image feature vector (Step S112).

The HV generation unit 31 executes HV encoding on the image feature vector of the query data and acquires a query HV (Step S113).

The matching unit 32 executes nearest neighbor matching by using the query HV for the class HVs accumulated in the HV memory 24, and specifies a class HV closest to the query HV (Step S114).

The output unit 33 outputs a class of the class HV specified by the matching unit 32 as a class to which the query data belongs (Step S115).

As described above, the inference apparatus according to the present embodiment generates and accumulates a class HV by thinning out low-quality learning data in learning, and performs inference by using the class HV. With this configuration, it is possible to improve classification accuracy even in a case where few-shot learning is performed by using a data set including low-quality learning data in learning.

### MODIFICATIONS

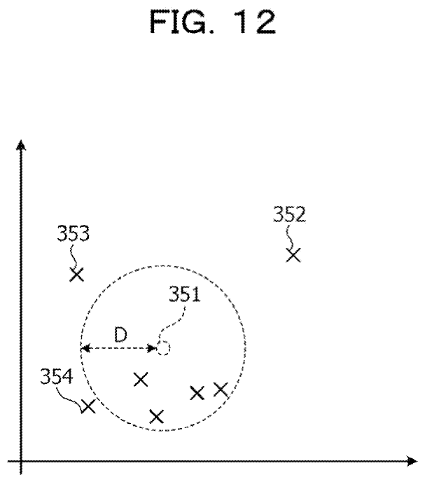

In the second embodiment, the HV whose distance from the temporary class HV is greater than the distance threshold is thinned out as an HV of low-quality learning data in learning, but other methods may be used as the thinning method. Hereinafter, other examples of the thinning method will be described. FIG. 12 is a diagram for describing other thinning methods.

For example, the thinning data determination unit 25 may determine a predetermined number of pieces of learning data from the farthest HV as objects to be thinned out. For example, in a case where HVs exist as in FIG. 12 and a temporary class HV represented by a point 351 is obtained, a point farthest from the point 351 is a point 352, and the next farthest point is a point 353. Thus, in a case where the predetermined number to be thinned out is set to 2, the thinning data determination unit 25 determines the HVs represented by the points 352 and 353 as the objects to be thinned out.

Furthermore, for example, the thinning data determination unit 25 may thin out HVs with a predetermined number as an upper limit from the farthest HV among HVs whose distance is equal to or greater than the distance threshold. For example, in a case where the distance threshold is set to D in the second embodiment, the thinning data determination unit 25 determines HVs whose distance is equal to or greater than D as objects to be thinned out. For example, in FIG. 12, three HVs represented by the points 352 to 354 outside a circle with a radius D centered at the point 351 are the objects to be thinned out. In addition to this, in a case where the number to be thinned out is limited by a predetermined number as an upper limit from the farthest HV, the thinning data determination unit 25 determines the HVs represented by the points 352 and 353 as the objects to be thinned out. For example, in a case where there are many HVs whose distance exceeds the distance threshold, it is possible to suppress a decrease in the number of learning samples by determining the upper limit number of thinning out.

Moreover, in addition to the thinning methods described above, it is also possible to determine an object to be thinned out by using a common abnormal value detection method such as K-nearest neighbor algorithm or a local outlier factor method. For example, in a case where the k-nearest neighbor algorithm is used, when a distance from one HV to another k-th nearest HV exceeds a predetermined neighborhood threshold, the thinning data determination unit 25 determines that the HV is an abnormal value, and determines the HV as an object to be thinned out.

Furthermore, in a case where the local outlier factor method is used, the thinning data determination unit 25 performs the following processing. Assuming that an HV of an abnormal value is HVp and the k-th nearest HV to HVp is HVq, a distance r(p) to the k-nearest point of the HVp is much greater than a distance r(q) to the k-nearest point of the HVq. Thus, a degree of abnormality of the HVp is defined as a(p)=r(p)/r(q), and in a case where a(p) exceeds an outlier threshold greater than 1, the thinning data determination unit 25 determines the HVp as an object to be thinned out.

Note that, in few-shot learning, it is assumed that an embedded application is performed on an edge side, which is a side of an apparatus connected to the cloud. It is difficult to arrange a high-performance computer as the apparatus on the edge side. Thus, it is preferable to suppress an amount of calculation of the inference apparatus 1 that performs the few-shot learning in the case of being arranged on the edge side. In this regard, in a case where the common abnormal value detection method such as the k-nearest neighbor algorithm or the local outlier factor method is used, the amount of calculation may increase because the distance is calculated for all combinations of HVs. Thus, in a case where an object to be thinned out is determined by using these common abnormal value detection methods, it is preferable to use these methods in an apparatus other than an apparatus having low processing capacity such as the apparatus on the edge side.

As described above, it is also possible to determine an object to be thinned out by using a value other than the distance threshold. In addition, also in a case where the object to be thinned out is determined by using a value other than the distance threshold to determine a class HV, few-shot learning may be performed by excluding low-quality learning data in learning, and classification accuracy may be improved.

### Hardware Configuration

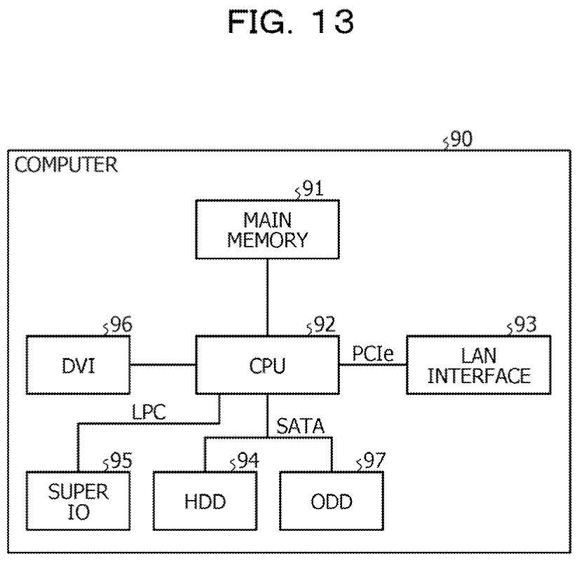

FIG. 13 is a diagram illustrating a hardware configuration of a computer that executes an inference program according to the embodiments. As illustrated in FIG. 13, a computer 90 includes a main memory 91, a central processing unit (CPU) 92, a local area network (LAN) interface 93, and a hard disk drive (HDD) 94. Furthermore, the computer 90 includes a super input output (IO) 95, a digital visual interface (DVI) 96, and an optical disk drive (ODD) 97.

The main memory 91 is a memory that stores a program, a halfway result of execution of the program, and the like. The CPU 92 is a central processing unit that reads a program from the main memory 91 and executes the program. The CPU 92 includes a chipset having a memory controller.

The LAN interface 93 is an interface for connecting the computer 90 to another computer via a LAN. The HDD 94 is a disk device that stores a program and data, and the super IO 95 is an interface for connecting an input device such as a mouse and a keyboard. The DVI 96 is an interface for connecting a liquid crystal display device, and the ODD 97 is a device that reads and writes data from and to a digital versatile disc (DVD).

The LAN interface 93 is connected to the CPU 92 by peripheral component interconnect express (PCIe), and the HDD 94 and the ODD 97 are connected to the CPU 92 by serial advanced technology attachment (SATA). The super IO 95 is connected to the CPU 92 by low pin count (LPC).

Then, the inference program executed by the computer 90 is stored in a DVD that is an example of a recording medium that may be read by the computer 90, and is read from the DVD by the ODD 97 to be installed to the computer 90. Alternatively, the inference program is stored in a database or the like of another computer system connected via the LAN interface 93, and is read from the database or the like to be installed to the computer 90. Then, the installed inference program is stored in the HDD 94, read to the main memory 91, and executed by the CPU 92.

Furthermore, in the embodiments, a case where image information is used has been described, but the inference apparatus may use, for example, another information such as audio information instead of the image information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an inference program that causes at least one computer to execute a process, the process comprising:
training a neural network based on a plurality of pieces of first learning data that belongs to a first certain number of object classes and that does not include second learning data;
generating a fully connected layer separated neural network by separating a fully connected layer of the neural network;
generating a learning feature by using the fully connected layer separated neural network for each of a second certain number of pieces of the first learning data for each of the object classes;
generating a class hyperdimensional vector for each of the object classes from each of the learning feature; and
storing the class hyperdimensional vector in association with the object classes in a memory.

2. The non-transitory computer-readable storage medium according to claim 1, wherein the process further comprising:
generating an inference object feature by using the fully connected layer separated neural network for inference object data that belongs to one of the object classes,
generating an inference object hyperdimensional vector from the inference object feature,
searching the memory based on the inference object hyperdimensional vector, and
acquiring a class of the class hyperdimensional vector that has a highest degree of matching with the inference object hyperdimensional vector.

3. The non-transitory computer-readable storage medium according to claim 1, wherein the process further comprising:
generating a hyperdimensional vector of the learning feature; and
generating the class hyperdimensional vector based on the hyperdimensional vectors.

4. The non-transitory computer-readable storage medium according to claim 1, wherein the generating the class hyperdimensional vector includes thinning out the first learning data that has an abnormal value from the second certain number of pieces of the first learning data.

5. The non-transitory computer-readable storage medium according to claim 4, wherein the process further comprising:
generating a temporary class hyperdimensional vector for each of the object classes by using the second certain number of pieces of the first learning data,
specifying the first learning data that has the abnormal value by comparing the temporary class hyperdimensional vector with the second certain number of pieces of the first learning data for each of the object classes, and
generating the class hyperdimensional vector for each of the object classes by thinning out the first learning data that has the abnormal value.

6. An inference method for a computer to execute a process comprising:
training a neural network based on a plurality of pieces of first learning data that belongs to a first certain number of object classes and that does not include second learning data;
generating a fully connected layer separated neural network by separating a fully connected layer of the neural network;
generating a learning feature by using the fully connected layer separated neural network for each of a second certain number of pieces of the first learning data for each of the object classes;
generating a class hyperdimensional vector for each of the object classes from each of the learning feature; and
storing the class hyperdimensional vector in association with the object classes in a memory.

7. The inference method according to claim 6, wherein the process further comprising:
generating an inference object feature by using the fully connected layer separated neural network for inference object data that belongs to one of the object classes,
generating an inference object hyperdimensional vector from the inference object feature,
searching the memory based on the inference object hyperdimensional vector, and
acquiring a class of the class hyperdimensional vector that has a highest degree of matching with the inference object hyperdimensional vector.

8. The inference method according to claim 7, wherein the process further comprising:
generating a hyperdimensional vector of the learning feature; and
generating the class hyperdimensional vector based on the hyperdimensional vectors.

9. The inference method according to claim 6, wherein the generating the class hyperdimensional vector includes thinning out the first learning data that has an abnormal value from the second certain number of pieces of the first learning data.

10. The inference method according to claim 9, wherein the process further comprising:
generating a temporary class hyperdimensional vector for each of the object classes by using the second certain number of pieces of the first learning data,
specifying the first learning data that has the abnormal value by comparing the temporary class hyperdimensional vector with the second certain number of pieces of the first learning data for each of the object classes, and
generating the class hyperdimensional vector for each of the object classes by thinning out the first learning data that has the abnormal value.
